(19) United States
(12) Patent Application Publication
(10) Pub. No.: US 2014/0330693 A1
(43) Pub. Date: Nov. 6, 2014

(54) SYSTEMS AND METHODS FOR AUCTIONING ASSET BACKED SECURITIES

(71) Applicant: Keith Siilats, New York, NY (US)

(72) Inventor: Keith Siilats, New York, NY (US)

(21) Appl. No.: 13/874,789

(22) Filed: May 1, 2013

(51) Int. Cl. G06Q 40/00

(52) U.S. Cl. CPC G06Q 40/04
USPC 705/37

(57) ABSTRACT

Provided are computer implemented methods and systems for auctioning asset backed securities. An online multi-stage auction system is provided based on peer-to-peer lending approach, where individual borrowers may sell shares in asset backed securities to partially finance the asset backed security or facilitate loans to purchase the asset backed securities. The auction system provides for a number of auctions to be held sequentially over a predetermined period of time. Lenders are provided with an option to sell their shares during each of the auctions. The total amount of shares allowable to be sold by lenders per auction should not exceed a predetermined threshold amount, otherwise the shares are sold in installments at subsequent auctions.

### FIELD

This application relates generally to computer system usable to coordinate auction processes in general and in particular to an online multi-stage auction system that facilitates lending transactions to reduce illiquidity of asset backed securities.

### BACKGROUND

In finance, the capital asset pricing model (CAPM) is used to determine a theoretically appropriate required rate of return of an asset. The model takes into account the asset's sensitivity to market risk, as well as the expected return of the market and the expected return of a theoretical risk-free asset. The CAPM is a model for pricing an individual security or portfolio and generally states that a similar investment should provide similar returns. However, the CAPM needs to be adjusted to take into consideration a premium associated with risky and illiquid investments.

An asset backed security (ABS) is a common illiquid asset. The ABS is a type of debt security that is based on pools of underlying assets. Assets are pooled to make otherwise minor and uneconomical investments worthwhile, while also reducing risk by diversifying the underlying assets. The ABS constitute a growing segment of the US, European, and global capital markets. In recent years the ABS market has enabled companies and banks to finance a wide range of assets in the public debt market and has attracted a variety of fixed-income investors. Securitization makes the asset backed securities available for investment to a broader set of investors. These asset pools can be made of any type of receivable from the common, like credit card payments, auto loans, and mortgages, to esoteric cash flows such as aircraft leases, royalty payments, and movie revenues. Typically, the securitized assets are highly illiquid and private in nature. Making ABS more liquid may be highly desirable.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter. Provided is a computer-implemented method for auctioning asset backed securities using a multi-stage auction system. In certain example embodiments, the method may include receiving a request from a borrower associated with the asset backed security to sell one or more borrower shares in the asset backed security, scheduling two or more borrower auctions to sell the one or more borrower shares, wherein a portion of the one or more borrower shares is sold at each borrower auction, initiating a first borrower auction to sell the one or more borrower shares, receiving one or more bids from one or more lenders to buy the one or more borrower shares, and selling the one or more borrower shares to the one or more lenders. The method may further include receiving one or more requests from the one or more lenders to sell one or more lender shares, initiating a second borrower auction according to the schedule to sell the one or more borrower shares, replacing the one or more borrower shares in the second borrower auction with the one or more lender shares for sale up to a predetermined threshold, and selling the one or more borrower shares and the one or more lender shares to one or more lenders. The one or more additional borrower auctions may be scheduled to sell the replaced one or more borrower shares.

In certain embodiments, a computer-implemented method for auctioning asset backed securities may involve selling the one or more borrower shares in the asset backed security to an investor prior to initiating the first borrower auction to sell the one or more borrower shares.

Provided also is a system for auctioning asset backed securities using an online auction system. The online auction system may comprise an operatively interconnected processor, a memory, and a network. The processor may be configured to receive a request from a borrower associated with the asset backed security to sell one or more borrower shares in the asset backed security, schedule two or more borrower auctions to sell the one or more borrower shares, wherein a portion of the one or more borrower shares is sold at each borrower auction, initiate a first borrower auction to sell the one or more borrower shares, receive one or more bids from one or more lenders to buy the one or more borrower shares, and sell the one or more borrower shares to the one or more lenders until a borrowing goal is satisfied. The processor may be further configured to receive one or more requests from the one or more lenders to sell one or more lender shares, initiate a second borrower auction according to the schedule to sell the one or more lender shares, replace the one or more borrower shares in the second borrower auction with the one or more lender shares for sale up to a predetermined threshold, and sell the one or more borrower shares and the one or more lender shares to one or more lenders. One or more additional borrower auctions may be scheduled to sell the replaced one or more borrower shares.

In certain embodiments, the one or more lender shares for sale in the second borrower auction may be limited by a predetermined number of shares.

In certain example embodiments, the one or more lender shares for sale may be decreased according to a number of the one or more lender shares owned by individual one or more lenders.

In certain example embodiments, the schedule may comprise two or more auctions, wherein the amount of borrower shares offered at each borrower auction is substantially equivalent.

In certain example embodiments, the asset backed security includes a mortgage associated with a real estate asset.

In certain example embodiments, the predetermined threshold is disclosed to the one or more lenders during the scheduling and the amount of lenders requesting to sell the one or more lender shares is not disclosed to the one or more lenders participating in the second borrower auction.

In certain example embodiments, the selling of the one or more borrower shares may be used to partially finance the asset backed security. Likewise, the selling of the one or more borrower shares may be also used to facilitate a loan to purchase the asset backed security.

In certain example embodiments, subsequent one or more borrower auctions may be initiated sequentially over a predetermined period of time. A number of the borrower auctions and an amount associated with each of the borrower auctions may be calculated to fund the loan within the predetermined period of time.

In certain example embodiments, the borrower may retain a predetermined number of shares in the asset backed security.

In certain example embodiments, the one or more shares for sale in the subsequent one or more borrower auctions may be limited by a predetermined number of shares.

Provided also is a machine-readable medium including instructions, which when implemented by one or more processors, perform the following operations. In one operation, a request from a borrower may be received, the request associated with the asset backed security to sell one or more borrower shares in the asset backed security. In further operation, two or more borrower auctions may be scheduled to sell the one or more borrower shares, wherein a portion of the one or more borrower shares is sold at each borrower auction. In further operations, a first borrower auction may be initiated to sell the one or more borrower shares. In another operation, one or more bids may be received from one or more lenders to buy the one or more borrower shares. In yet another operation, the one or more borrower shares may be sold to the one or more lenders until a borrowing goal is satisfied. In yet another operation, one or more requests may be received from the one or more lenders to sell one or more lender shares. In further operation, a second borrower auction may be initiated as per the schedule to sell the one or more borrower shares. In yet another operation, the one or more borrower shares in the second borrower auction may be replaced with the one or more lender shares up to a predetermined threshold, and the one or more borrower shares and the one or more lender shares may be sold to one or more lenders. In yet another operation, one or more additional borrower auctions may be scheduled to sell the replaced one or more borrower shares.

The following detailed description together with the accompanying drawings will provide a better understanding of the nature and advantages of the present invention.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating an example of the overall system for auctioning asset backed securities, in which various embodiments may be implemented.

FIG. 2 is a schematic representation of elements of a system for auctioning asset backed securities, in accordance with certain embodiments.

FIG. 3 is a flow chart illustrating a method for auctioning asset backed securities, in accordance with certain embodiments.

FIG. 4 is a flow chart showing an example process for using a computer system for conducting a plurality of auctions to sell one or more borrower shares in an asset backed security, in accordance with certain embodiments.

FIG. 5 is a schematic diagram illustrating an example of a computer system for performing any one or more of the methods discussed herein.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

Various computer-implemented method and system for auctioning asset backed securities are described herein. In particular, provided is a special type of an online auction marketplace, wherein borrowers may request personal loans to purchase or partially finance an asset backed security and lenders are provided with an option to sell their loans to other participants of the auction.

Peer-to-peer lending (also known as person-to-person lending, peer-to-peer investing, and social lending; abbreviated frequently as P2P lending) is the practice of lending money to unrelated individuals, or “peers”, without going through a traditional financial intermediary such as a bank or other traditional financial institution.

In certain example embodiments, system for auctioning asset backed securities may be implemented via an online auction system that enables borrowers to attract lenders and investors to purchase borrower shares in the asset backed securities.

The online auction system facilitates lending money, auctioning of loans, funds transactions, and the like, via a communication network, for example, Internet. The auction system may comprise an auction server and auction website. The auction server may comprise client interaction means operable to interact with borrowers and lenders and to post their requests and bids on the auction website.

The auction system and related method may be used by potential lenders and borrowers to lend and borrow anonymously with anonymity maintainable throughout the lending process, including repayment. Potential borrowers and lenders may use their client devices to access the online auction system on the auction website using an auction user interface. The auction system may be well suited for individual borrowers and individual lenders that cannot meet the standards of conventional lending institutions.

In certain example embodiments, a potential borrower may submit to the auction system a borrowing request associated with an asset backed security to sell one or more shares in the asset backed security. The borrower may retain a number of shares in the asset backed security. The request from the borrower may include the amount of money to be lent to the borrower. In certain example embodiments, the request from the borrower may include personal information associated with the borrower, such as the borrower's location, the type of an asset backed security the borrower will engage in, borrower reputation information. Once the borrower request is verified, two or more borrower auctions may be scheduled to sell the one or more borrower shares, wherein a portion of the one or more borrower shares is sold at each borrower auction. The schedule may be predetermined prior to initiating a first borrower auction. The borrower may optionally modify the schedule (i.e. add more auctions) during the one or more borrower auctions.

A first borrower auction may be initiated to sell one or more borrower shares, and the request from the borrower may then be posted on the auction website for bidding by potential lenders.

In certain example embodiments, individual lenders may access the online auction system on the auction website to submit a bid to buy one or more borrower shares. In certain example embodiments, the auction server may comprise bid selection means operable to select bids according to predetermined criteria set by a borrower and further operable to present the selected bids to the borrower for acceptance of the loan offer.

In certain example embodiments, lenders are provided with an option to sell one or more shares to other participants of the auction. The client interaction means may be operable to receive a request from a lender to sell one or more shares purchased during the auction to other participants of the auction. A second borrower auction may be initiated according to the schedule to sell the one or more borrower shares. The one or more borrower shares in the second borrower auction may be replaced with the one or more lender shares up to a predetermined threshold. The one or more lender shares up to a predetermined threshold amount may be sold first. The maximum threshold amount of lender shares for sale may be disclosed to lenders during the auction. However, the actual amount of lender shares sold is not disclosed to other lenders.

The one or more borrower shares and the one or more lender shares may be sold to one or more lenders participating in the second borrower auction. The remaining lender shares may be sold at subsequent one or more borrower auctions initiated sequentially over a predetermined periods of time. One or more additional borrower auctions may be scheduled to sell the replaced one or more borrower shares.

In certain example embodiments, the client interaction means may determine that the one or more lender shares to be sold exceed a predetermined threshold amount, and based on the determination, decrease the one or more lender shares for sale until the one or more lender shares for sale are below the predetermined threshold amount.

In certain example embodiments, the one or more lender shares for sale are decreased according to a number of the one or more lender shares owned by individual one or more lenders. For example, a lender may sell only one share per auction. The one or more lender shares for sale in the subsequent borrower auctions may be as well limited by a predetermined threshold amount. For example, a borrower may set up an auction to collect fifty thousand dollars. A lender may buy the fifty thousand dollars share of the borrower at a first borrower auction. Eventually the lender may decide to sell the fifty thousand dollars share and submits the selling requests to the auction system. Upon submitting the request to sell the share the borrower may have set up the threshold amount of shares for sale per auction up to 50% of the total auction value. So, the amount of the lender share is decreased to twenty five thousand dollars and is sold to a participant of the auction at the second borrower auction initiated by the online auction system. The remaining twenty five thousand dollars may be sold at subsequent one or more borrower auctions.

In certain example embodiments, the auction system may be further configured to initiate subsequent one or more borrower auctions to sell lender shares and borrower shares. In general the first borrower action, the second borrower action, and the subsequent one or more borrower auctions may be initiated sequentially over a predetermined periods of time. A number of borrower auctions and an amount associated with each of the borrower auctions may be calculated to fund the loan within a predetermined period of time. For example, a borrower purchases an asset backed security for one million dollars and needs a one hundred thousand dollars loan. The auction system may set up two monthly auctions to collect fifty thousand dollars at each auction. So in two months the borrower will get the whole one hundred thousand dollars loan.

In certain example embodiments, a borrower may sell one or more borrower shares in an asset backed security to an investor prior to initiating a borrower auction. For example, a borrower urgently needs a predetermined sum of money and does not want to wait till the end of an auction to collect the sum of money. In this case the borrower submits a request to the auction system to find an investor available to lend money at the present moment specifying the details of loan in his request. The system may match the request with offers of investors registered in the auction system and provide a list of investors meeting the requirements of the borrower request. Whereupon the borrower may choose an investor best suited for his requirements and entrust the investor to initiate and coordinate borrower auctions.

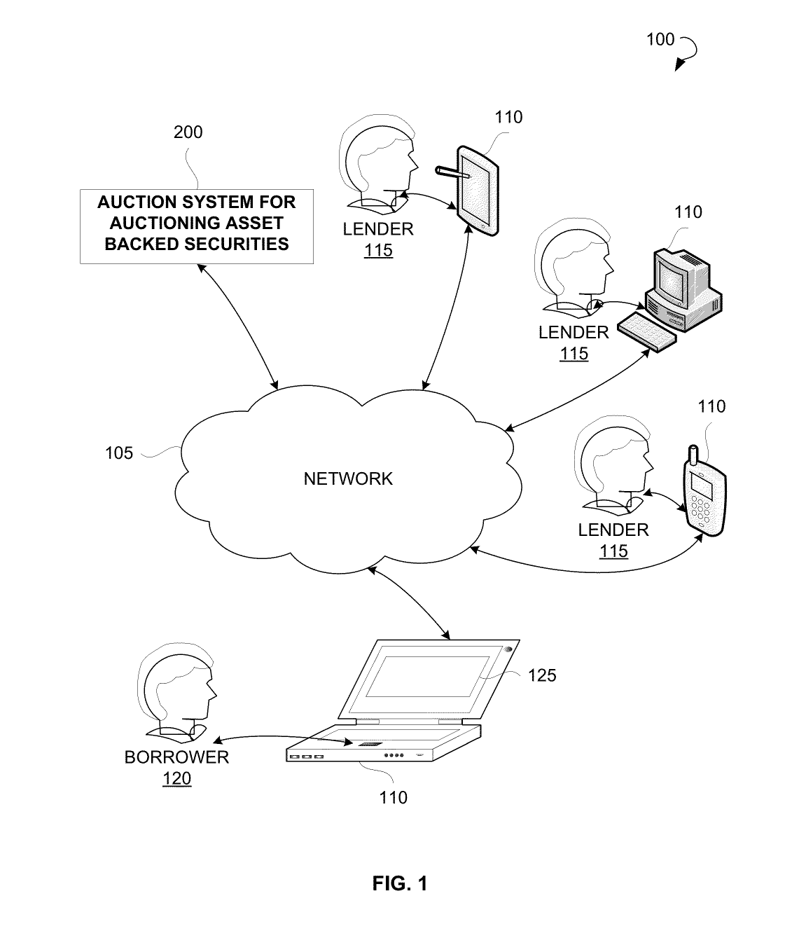

Referring now to drawings, FIG. 1 illustrates an exemplary environment 100 for the system for auctioning asset backed securities, in which various embodiments may be implemented.

The auction system 200 for auctioning asset backed securities may be accessible by lenders 115 and borrowers 120 on an auction website 125 via a network 105. The auction system 200 may include an auction server (not shown) that may be a single server providing all functions, or may be designed as a “cloud server”, where single network address access is provided to the combined services of a plurality of servers in co-operation with one another.

The auction website 125 may operate as a peer-to-peer lending website. The auction server may provide two-way communications between numerous individuals that may access the auction website 125 using various client devices 110.

The client device 110 may include, but is not limited to, portable personal computers (PC), desktop personal computers, portable tablet computers, and mobile telephone devices. In general, the client device 110 may be any device with network 105 access enabled.

The network 105 may take any suitable form, such as a wide area network or Internet and/or one or more local area networks (LAN's). The network 104 may include any suitable number and type of devices, e.g., routers and switches, for forwarding commands, content, and/or web object requests from each client to the online community application and responses back to the clients. The network 105 may include, for example, TCP/IP-based networks, telecommunications networks, wireless networks, etc.

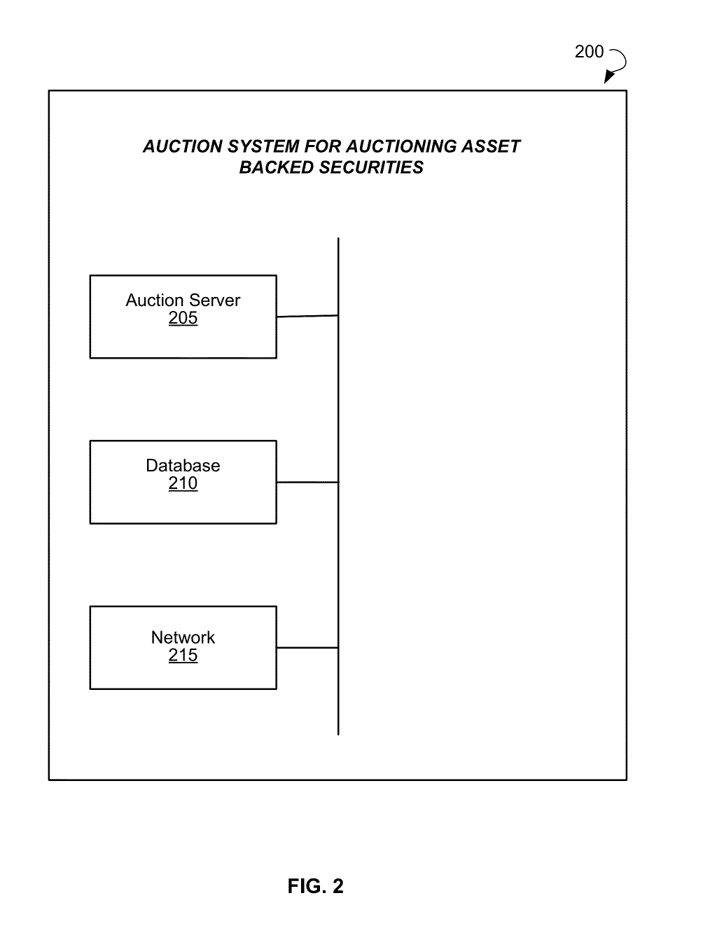

FIG. 2 schematically shows elements of the auction system 200 for auctioning asset backed securities, in accordance with certain embodiments. The auction system 200 may comprise an auction server 205 configured to provide an auction website for various types of individual users, groups of individuals and organizations to interact with each other by way of borrowing and lending personal funds. The auction server 205 may further comprise client interaction means operable to interact with various client devices of users of the auction system and coordinate offers (bids) and requests from borrowers, lenders, investors, and other users of the auction system 200. The client interaction means may be configured to receive requests from various categories of users, in particular borrowers, lenders, or investors. The requests may include a request to borrow money, a request to sell one or more shares in an asset backed security, a request to buy the one or more shares in the asset backed security, a request to initiate a plurality of borrower auctions, and the like. The client interaction means may be further operable to receive bids from potential lenders or investors to buy one or more shares in asset backed securities or invest in personal loans.

The auction system 200 may further include a database 210. The database 210 may be configured to store personal data associated with users of the auction system 200, such as user ID, personal identifiers, ratings, user reputation information, bank information, borrowing criteria and the like.

The auction system 200 may further include a network 215. The network 215 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34b is analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 215 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analogue interface or connection, mesh or Digi® networking. The network 215 may include any suitable number and type of devices, e.g., routers and switches, for forwarding commands, content, and/or web object requests from each client to the online community application and responses back to the clients.

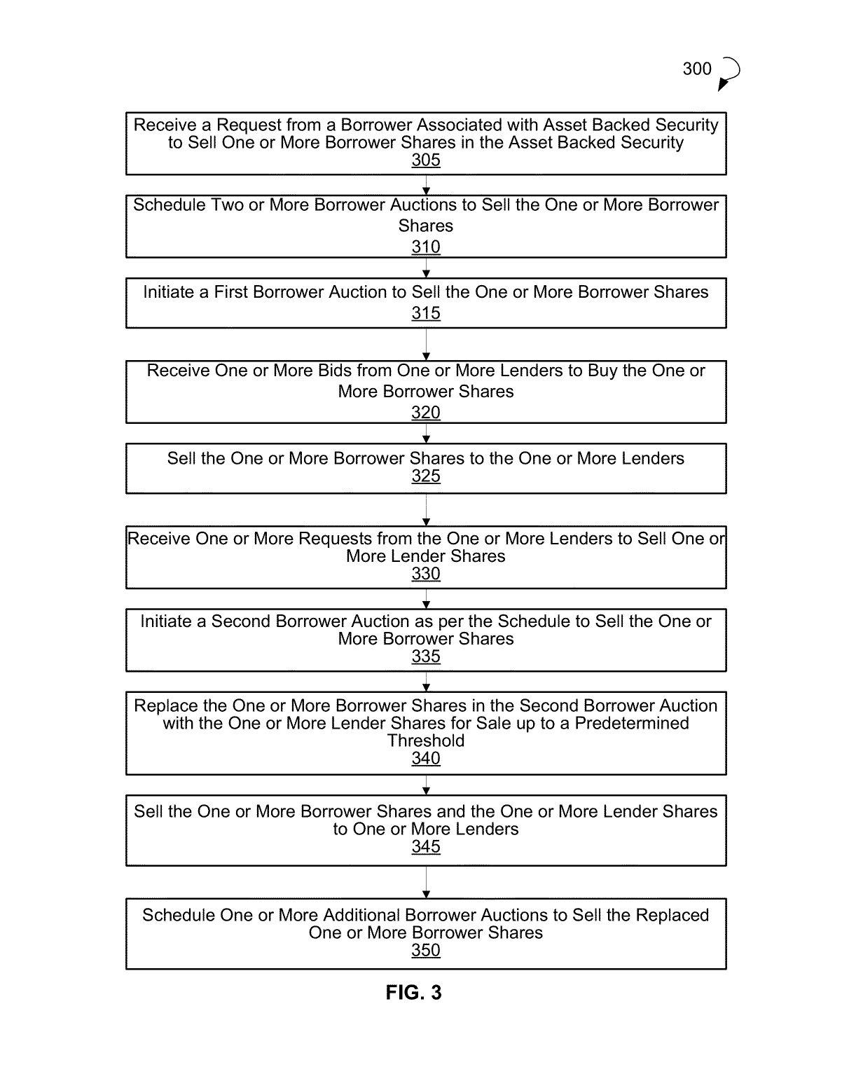

FIG. 3 is a flow chart illustrating a method 300 for auctioning asset backed securities, in accordance with certain embodiments. The method 300 may start with receiving a request from a borrower associated with the asset backed security to sell one or more borrower shares in the asset backed security in operation 305. The borrower may wish to obtain a loan from one or more potential lenders or investors. To obtain the loan, the borrower may submit a corresponding request to sell one or more shares in an asset backed security to an auction system. The request may be verified to correspond to certain policy criteria. After the verification and confirmation of the borrower request the system, at operation 310, schedules, two or more borrower auctions to sell one or more borrower shares. At operation 315, a first borrower auction may be initiated to sell the one or more borrower shares. One or more lenders may be automatically notified of the opening of the new borrower auction or may search among the pages made available by an auction website.

At operation 320, the method 300 may involve receiving one or more bids from one or more lenders to buy the one or more borrower shares. The one or more lenders may offer bids to fill the borrowing request at rates of interest set down by each particular lender. Different lender bids are gathered and provided to the borrower for approval.

At operation 325, the method 300 may proceed with selling the one or more borrower shares to the one or more lenders until a borrowing goal is satisfied. The borrowing goal may include collecting the desired loan amount at the first borrower auction.

At operation 330, the method 300 may involve receiving one or more requests from the one or more lenders to sell the one or more lender shares. A lender, in response to his request to sell one or more of his shares, may receive a notification informing that this particular auction sets a limit on the amount or number of lender shares for sale. In certain example embodiments, lenders may be notified of the limit in advance at entering of an auction.

At operation 335, a second borrower auction may be initiated as per the schedule to sell the one or more borrower shares. The one or more lender shares may be sold in the second borrower action together with other one or more borrower shares, meaning that other participants of the auction are not aware of the fact that lender shares are being sold at the auction.

At operation 340, the one or more borrower shares may be replaced in the second borrower auction with the one or more lender shares for sale up to a predetermined threshold.

At operation 345, the one or more borrower shares and the one or more lender shares may be sold to one or more lenders.

At operation 350, one or more additional borrower auctions may be scheduled to sell the replaced one or more borrower shares.

In certain example embodiments, the subsequent one or more borrower actions may be initiated when a borrower does not collect a desired amount of loan at previous two borrower auctions. The subsequent auctions may be conducted sequentially over predetermined periods of time until the borrowing goal is satisfied.

In certain example embodiments, the auction system may verify the number and total amount of shares the lender desires to sell. In case the amount of lender shares exceeds a predetermined threshold amount, the amount is decreased until it is below the predetermined threshold amount, whereupon the decreased one or more shares may be put up for the lender auction. The remaining portion of the one or more lender shares may be sold at subsequent auctions set up by the borrower. The threshold amount of lender shared to be sold per one auction may be predefined by the borrower in his request. For example, the borrower may set a maximum amount of shares to be sold per auction to 50% of the total auction amount, so that the borrower receives a substantial portion of the auction in the worst case. In certain example embodiments, the borrower may set up a number of backup auctions in case he does not collect the desired loan amount during initial series of auction.

In certain embodiments, the method 300 may include an optional operation that involves selling the one or more borrower shares in an asset backed security to an investor prior to initiating the first borrower auction to sell the one or more borrower shares.

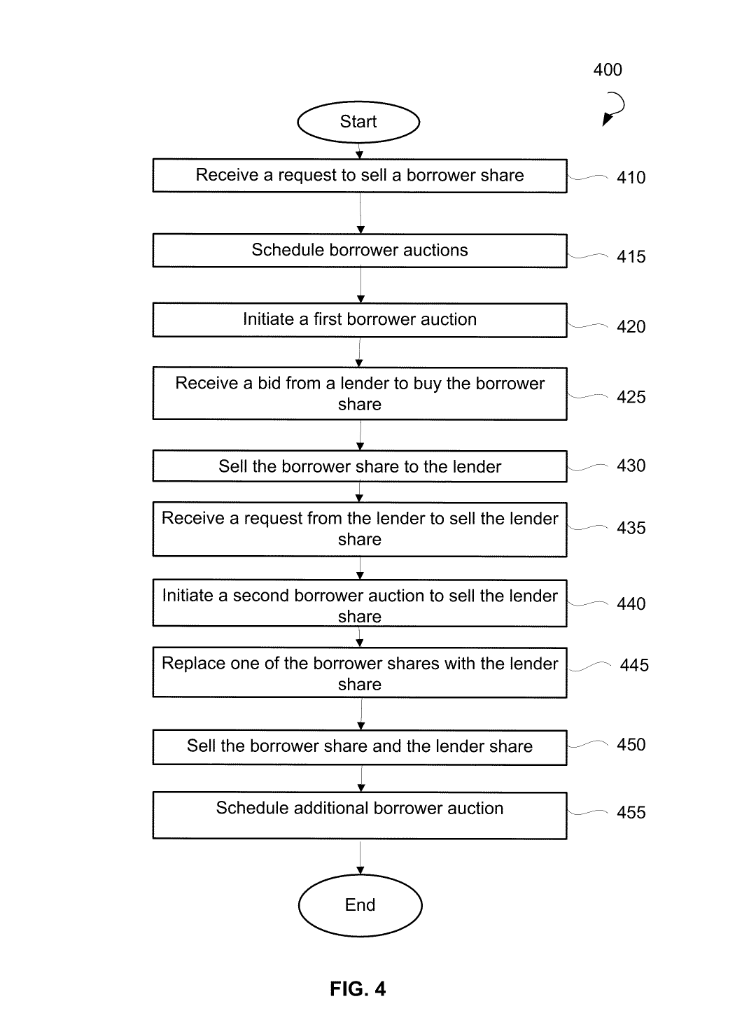

FIG. 4 is a flow chart showing an example method for using a computer system for conducting an auction to sell one or more borrower shares in an asset backed security, in accordance with certain embodiments.

An example method 400 starts with receiving, at operation 410, a request from a borrower to sell a $100,000 share in an asset backed security to partially finance his asset backed security. The borrower may enter an auction website via his networked client device, i.e. a smart phone, and submit the request to sell the share via an auction user interface. The borrower may specify in his request the number of auctions to be held and the duration of each auction. Alternatively, the auction system may calculate the number of auctions and the amount associated with each auction automatically according to a predetermined criteria specified by the borrower in his request. The borrower also specifies that the threshold amount of lender shares for sale per auction should not exceed 50% of the auction value. So, at operation 415, the auction system may schedule two borrower auctions to sell the borrower share. At operation 420, the auction system may initiate a first auction for collecting $50,000. At the first auction, at operation 425, the auction system may receive a $20,000 bid from a first lender and a $30,000 bid from a second lender and provides the loan offers to the borrower for approval. The borrower considers the interest rates offered by the lenders, as well as other information associated with the lenders and accepts the loan offers of the lenders, at operation 430. Later, the second lender decides to sell his $30,000 share and submits the selling request via the auction user interface, at operation 435. The auction system, at operation 440, initiates a second borrower auction to sell the lender share and replaces one of the borrower shares with the lender share for sale, at operation 445. At operation 450, the system sells the borrower shares together with the lender share or a portion of the lender share. For example, the system may determine that the lender share for sale exceeds the predetermined threshold amount specified by the borrower and sell only a portion of $25,000. In a month, the auction system initiates additional borrower auctions, at operation 455, to sell the replaced borrower share and the remaining $5,000 of the lender share. The borrower receives a $30,000 bid from the forth lender and a $20,000 bid from the fifth lender, thereby raising the full 100% of the desired loan.

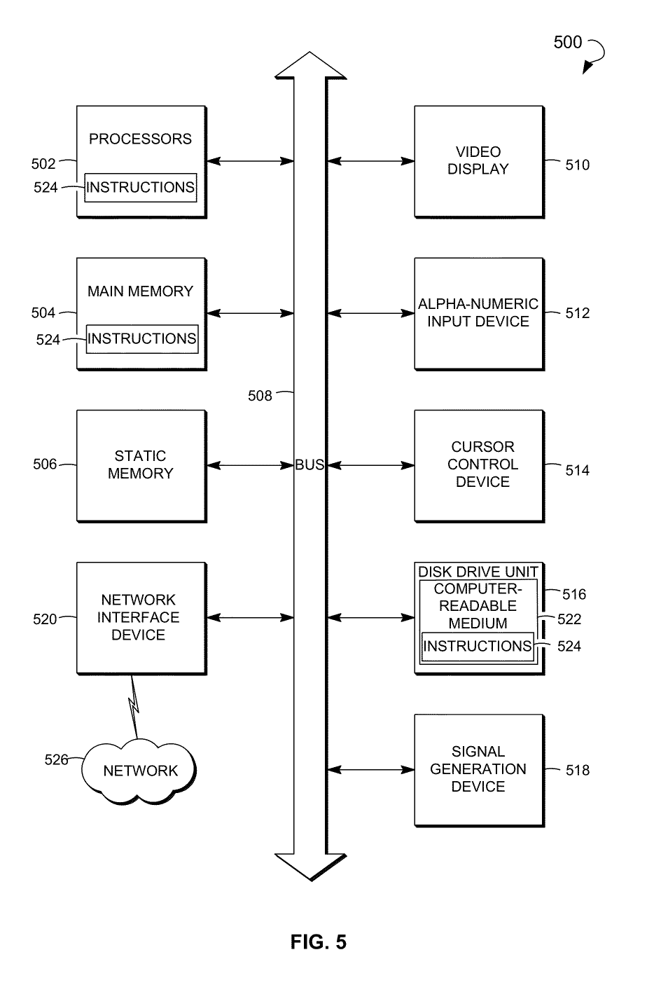

FIG. 5 shows a diagrammatic representation of a machine in the example electronic form of a computer system 500, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 may also include an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a computer-readable medium 522, on which is stored one or more sets of instructions and data structures (e.g., instructions 524) embodying or utilized by any one or more of the methodologies or functions described herein. The instructions 524 may also reside, completely or at least partially, within the main memory 504 and/or within the processors 502 during execution thereof by the computer system 500. The main memory 504 and the processors 502 may also constitute machine-readable media.

The instructions 524 may further be transmitted or received over a network 526 via the network interface device 520 utilizing any one of a number of well-known transfer protocols (e.g., Hyper Text Transfer Protocol (HTTP)).

While the computer-readable medium 522 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, various systems and methods for auctioning of asset backed securities have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. A computer-implemented method for auctioning asset backed securities, the method comprises:
receiving, by a processor, a request from a borrower associated with the asset backed security to sell one or more borrower shares in the asset backed security;
scheduling, by the processor, two or more borrower auctions to sell the one or more borrower shares, wherein a portion of the one or more borrower shares is sold at each borrower auction;
initiating, by the processor, a first borrower auction to sell the one or more borrower shares;
receiving, by the processor, one or more bids from one or more lenders to buy the one or more borrower shares;
selling, by the processor, in the first borrower auction, the one or more borrower shares to the one or more lenders;
receiving, by the processor, one or more requests from the one or more lenders to sell one or more lender shares, wherein the one or more lender shares include the one or more borrower shares sold to the one or more lenders;
receiving, by the processor, a request from the borrower to set a threshold of the one more lender shares offered for sale at a second borrower auction;
in response to the request received from the borrower, setting, by the processor, the threshold of the one or more lender shares offered for sale at the second borrower auction;
initiating, by the processor, the second borrower auction as per the schedule to sell the one or more borrower shares;
replacing, by the processor, the one or more borrower shares in the second borrower auction with the one or more lender shares for sale up to the threshold;
selling, by the processor, in the second borrower auction, the one or more borrower shares and the one or more lender shares to one or more lenders, wherein the one or more lender shares are sold first; and
scheduling, by the processor, one or more additional borrower auctions to sell the replaced one or more borrower shares.

2. The method of claim 1, wherein the one or more lender shares for sale in the second borrower auction are limited by a predetermined number of shares.

3. The method of claim 1, wherein the schedule comprises two or more auctions, wherein the amount of borrower shares offered at each borrower auction is equivalent.

4. The method of claim 1, wherein the asset backed security is a mortgage on a real estate.

5. The method of claim 1, wherein the threshold is disclosed to the one or more lenders during the scheduling and the amount of lenders requesting to sell the one or more lender shares is not disclosed to the one or more lenders participating in the second borrower auction.

6. The method of claim 1, further comprising initiating subsequent one or more borrower auctions, wherein the subsequent one or more borrower auctions are initiated sequentially over a predetermined period of time.

7. The method of claim 1, wherein a number of borrower auctions and an amount associated with each of the borrower auctions are calculated to fund the loan within a predetermined period of time.

8. The method of claim 1, wherein the borrower retains a predetermined number of shares in the asset backed security.

9. The method of claim 6, wherein the one or more lender shares for sale in the subsequent one or more borrower auctions are limited by a predetermined number of shares.

10. The method of claim 1, further comprising selling the one or more borrower shares in the asset backed security to an investor prior to initiating the first borrower auction to sell the one or more borrower shares.

11. A computer-implemented system for auctioning asset backed securities, the system comprises:
an electronic auction platform comprising an operatively interconnected processor, a memory, and a network, wherein the processor is configured to:
receive a request from a borrower associated with the asset backed security to sell one or more borrower shares in the asset backed security;
schedule two or more borrower auctions to sell the one or more borrower shares, wherein a portion of the one or more borrower shares is sold at each borrower auction;
initiate a first borrower auction to sell the one or more borrower shares;
receive one or more bids from one or more lenders to buy the one or more borrower shares;
sell, in the first borrower auction, the one or more borrower shares to the one or more lenders;
receive one or more requests from the one or more lenders to sell one or more lender shares, wherein the one or more lender shares include the one or more borrower shares sold to the one or more lenders;
receive a request from the borrower to set a threshold of the one more lender shares offered for sale at a second borrower auction;
in response to the request received from the borrower, set the threshold of the one or more lender shares offered for sale at the second borrower auction;
initiate the second borrower auction as per the schedule to sell the one or more borrower shares;
replace the one or more borrower shares in the second borrower auction with the one or more lender shares for sale up to the threshold;
sell the one or more borrower shares and the one or more lender shares to one or more lenders, wherein the one or more lender shares are sold first; and
schedule one or more additional borrower auctions to sell the replaced one or more borrower shares.

12. The system of claim 11, wherein the schedule comprises two or more auctions, wherein the amount of borrower shares offered at each borrower auction is equivalent.

13. The system of claim 11, wherein the asset backed security is a mortgage on a real estate.

14. The system of claim 11, where the threshold is disclosed to the one or more lenders during the scheduling and the amount of lenders requesting to sell the one or more lender shares is not disclosed to the one or more lenders participating in the second borrower auction.

15. The system of claim 11, further comprising initiating one or more subsequent borrower auctions, wherein the one or more subsequent borrower auctions are initiated sequentially over a predetermined period of time.

16. The system of claim 11, wherein a number of the borrower auctions and an amount associated with each of the borrower auctions are calculated to fund the loan within the predetermined period of time.

17. The system of claim 11, wherein the borrower retains a predetermined number of shares in the asset backed security.

18. The system of claim 15, wherein the one or more shares for sale in the subsequent one or more borrower auctions are limited by a predetermined number of shares.

19. The system of claim 11, further comprising selling the one or more borrower shares in the asset backed security to an investor prior to initiating the first borrower auction to sell the one or more borrower shares.

20. A non-transitory machine-readable medium comprising instructions, which when implemented by one or more processors, perform the following operations:
receive a request from a borrower associated with the asset backed security to sell one or more borrower shares in the asset backed security;
schedule two or more borrower auctions to sell the one or more borrower shares, wherein a portion of the one or more borrower shares is sold at each borrower auction;
initiate a first borrower auction to sell the one or more borrower shares;
receive one or more bids from one or more lenders to buy the one or more borrower shares;
sell, in the first borrower auction, the one or more borrower shares to the one or more lenders until a borrowing goal is satisfied;
receive one or more requests from the one or more lenders to sell one or more lender shares, wherein the one or more lender shares include the one or more borrower shares sold to the one or more lenders;
receive a request from the borrower to set a threshold of the one more lender shares offered for sale at a second borrower auction;
in response to the request received from the borrower, set the threshold of the one or more lender shares offered for sale at the second borrower auction;
initiate the second borrower auction as per the schedule to sell the one or more borrower shares;
replace the one or more borrower shares in the second borrower auction with the one or more lender shares up to the threshold;
sell, in the second borrower auction, the one or more borrower shares and the one or more lender shares to one or more lenders, wherein the one or more lender shares are sold first; and
schedule one or more additional borrower auctions to sell the replaced one or more borrower shares.
